(19) United States
(12) Patent Application Publication
(10) Pub. No.: US 2026/0348715 A1
(43) Pub. Date: Nov. 5, 2026

(54) DEVICES, SYSTEMS, AND METHODS FOR DETERMINING PHYSICAL CHARACTERISTICS ASSOCIATED WITH MULTIPLE ZONES OF A CIRCUIT

(71) Applicant: Liquid Wire Inc., Portland, OR (US)

(72) Inventors: Cade Michael Terrill Johnson, Canby, OR (US); Michael Adventure Hopkins, Portland, OR (US)

(73) Assignee: Liquid Wire Inc., Portland, OR (US)

(21) Appl. No.: 19/640,104

(22) Filed: Apr. 6, 2026

Related U.S. Application Data
(60) Provisional application No. 63/783,700, filed on Apr. 4, 2025.
(60) Provisional application No. 63/783,686, filed on Apr. 4, 2025.

(51) Int. Cl. G01B 7/16; G01L 5/16

(52) U.S. Cl. CPC G01B 7/16; G01L 5/16

(57) ABSTRACT

Devices, systems, and methods for determining physical characteristics associated with multiple zones of a deformable-conductor circuit are disclosed. A circuit including a plurality of traces formed from a deformable conductor is provided. The plurality of traces includes a common trace defining a sensing range and configured to conduct a constant electrical parameter, and at least one sensing trace electrically coupled to the common trace at a tap point within the sensing range. The sensing trace defines a sensing zone at least partially overlapping the sensing range and is configured to generate a sensing variable within the sensing zone. A control circuit may be communicably coupled to the common trace and the sensing trace, configured to receive signals and determine at least one physical characteristic associated with an article based on the signals. The circuit may include a sensing trace array with multiple sensing traces defining multiple sensing zones.

### CROSS-REFERENCE TO RELATED APPLICATIONS

This application claims the benefit of U.S. Provisional Application No. 63/783,686, filed Apr. 4, 2025, and U.S. Provisional Application No. 63/783,700, filed Apr. 4, 2025, each of which is incorporated herein by reference in its entirety. All applications referenced herein are relevant to the subject matter disclosed herein and are hereby incorporated by reference in their entirety, regardless of the specific portion of the specification in which they are referenced.

### FIELD

The present disclosure is generally related to circuits incorporating deformable conductors and, more particularly, is directed to circuits with multiple tap points which can define multiple sensing zones, and which can be integrated to articles for the purposes of determining physical characteristics associated with multiple zones of the article.

### SUMMARY

The following summary is provided to facilitate an understanding of some of the innovative features unique to the aspects disclosed herein and is not intended to be a full description. A full appreciation of the various aspects and embodiments can be gained by taking the entire specification, claims, and abstract as a whole.

A circuit is disclosed that includes a plurality of traces formed from a deformable conductor. The plurality of traces can include a common trace defining a sensing range and a sensing trace electrically coupled to the common trace at a tap point within the sensing range. The common trace can be configured to conduct a constant electrical parameter, and the sensing trace can define a sensing zone at least partially overlapping the sensing range. The sensing trace can be configured to generate a sensing variable within the sensing zone.

In some embodiments, the circuit can further include a control circuit communicably coupled to the common trace and the sensing trace. The control circuit can be configured to generate the constant electrical parameter, receive a first signal from the common trace associated with the constant electrical parameter, and receive a second signal from the sensing trace associated with the sensing variable. The circuit can be configured for use with an article, and the control circuit can be further configured to determine at least one physical characteristic associated with the article based on at least the first and second signals.

Further, the circuit can include a sensing trace array comprising the sensing trace and at least one additional sensing trace. Each additional sensing trace can be electrically coupled to the common trace at an additional tap point within the sensing range, can define an additional sensing zone at least partially overlapping the sensing range, and can be configured to generate an additional sensing variable within each additional sensing zone.

In some embodiments, a system is disclosed including an article and a circuit integrated to the article. The circuit can include a plurality of traces formed from a deformable conductor, wherein the plurality of traces can include a common trace configured to traverse a first portion of the article and a second portion of the article, and a sensing trace electrically coupled to the common trace at a tap point. The system can further include a control circuit communicably coupled to the circuit, wherein the control circuit is configured to receive a signal from the sensing trace, the signal associated with an electrical characteristic of the common trace at the tap point, and determine a physical characteristic associated with the first portion of the article based on the signal.

Additionally, a method of determining a physical characteristic associated with a portion of an article is disclosed. The method can include providing a constant electrical parameter to a common trace, the common trace and a sensing trace each formed from a deformable conductor, the sensing trace electrically coupled to the common trace at a tap point. The method can further include receiving, by a control circuit, a first signal from the common trace and a second signal from the sensing trace, and determining, by the control circuit, a physical characteristic associated with a first portion of the article based on at least the first and second signals.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 is a schematic illustration of a circuit with multiple tap points for determining physical characteristics associated with multiple portions or zones of the circuit, in accordance with at least one non-limiting aspect of the present disclosure;

FIG. 2 is a schematic illustration of a circuit with a branching topology and multiple tap points for determining physical characteristics associated with multiple zones of the circuit across a plurality of branches, in accordance with at least one non-limiting aspect of the present disclosure;

FIG. 3 is a schematic illustration of a circuit without tap points for determining physical characteristics associated with multiple portions of the circuit using discrete sensing traces, in accordance with at least one non-limiting aspect of the present disclosure;

FIG. 4 is a schematic illustration of a method of determining a physical characteristic associated with a first portion of an article, in accordance with at least one non-limiting aspect of the present disclosure;

FIG. 5 is a schematic illustration of a method of determining a physical characteristic associated with a first portion of an article and a physical characteristic associated with a second portion of the article, in accordance with at least one non-limiting aspect of the present disclosure;

FIG. 6 is a schematic illustration of a measurement system including an analog-to-digital converter configured to measure electrical characteristics at multiple tap points of a multi-tap circuit, in accordance with at least one non-limiting aspect of the present disclosure;

FIG. 7 is a schematic illustration of an equivalent circuit representation of a multi-tap circuit showing a resistor network formed by a common trace and a plurality of sensing traces, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

In the following description, like reference characters designate like or corresponding parts throughout the several views of the drawings.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves any and all copyrights disclosed herein.

Electronic circuits that are flexible and more deformable than traditional rigid and flex PCBs have emerged as a means of innovating conventional electronics and introducing electronics into new products and applications. For example, flexible, and in some cases stretchable, electronic circuits are being introduced into new products and applications for determining and analyzing physical characteristics of a wearable article based on received signals associated with electrical parameters. While certain electronic circuits typically have some inherent flexibility, that flexibility is typically constrained both in the amount the circuits can flex, their resilience in flexing, and the number of times the electronic circuits can flex before the electronic circuits deteriorate or break. Consequently, the utility of such electronic circuits in various environments may be limited, either by reliability or longevity or by the ability to function at all. The use of deformable conductors (e.g., conductive gels) in place of traditional conductors and deposited as traces on flexible and/or stretchable substrates to make a circuit, however, may provide for electronic circuits that are not only flexible, but also stretchable and highly deformable while maintaining resiliency and enhancing durability. Moreover, the operational flexing, stretching, deforming, or other physical manipulation of a conductive trace formed from some deformable conductors may produce predictable, measurable changes in the electrical parameters conducted by the trace, which in turn can be correlated to physical characteristics of the trace itself and the circuit that includes it. Such flexible and/or stretchable circuits can be configured as various types of sensors integrating traces made from such a deformable conductor. Such sensors can be integrated to an article, and changes in the physical characteristics of the circuits and associated changes in the electrical parameters conducted by their traces can further be correlated to changes in the physical characteristics of the article.

Implementation of circuits having a single trace extending over a linear or areal range and configured to sense changes in the circuit's physical characteristics within that range can make it difficult to determine discrete changes in physical characteristics associated with, or distributed over, multiple portions of the range. For example, such a circuit may be integrated to an article to measure, track, log or monitor physical changes to the article over time. The circuit's single trace will generate an aggregate signal in response to multiple physical changes occurring simultaneously at different locations on the article. In many cases, it may be impossible to isolate individual contributions to the signal resulting from such discrete physical changes, and/or determine where each physical change occurred within the range covered by the circuit. For this reason, when needing to measure, log, or track changes in physical characteristics in multiple locations of an article, the prevailing solution has been to integrate multiple circuits (e.g., sensors) to the article, where each sensing circuit monitors a discrete zone of the article. However, this creates packaging issues and increased complexity of such devices and systems. Additionally, integrating multiple circuits may increase the number of required layers in an article, system, or structure, since at least portions of the various sensing circuits may need to overlap one another. Increasing the number of layers in flexible and/or stretchable electronics, however, reduces the flexibility and/or stretchability of such electronics. As an example of why this is undesirable, in wearable applications such reduced flexibility and/or stretchability causes increased physical resistance to a wearer's movements which results in discomfort, fatigue, and/or limits the wearer's freedom of movement. Accordingly, there is a need for improved devices, systems, and methods for determining physical characteristics associated with multiple zones of a circuit.

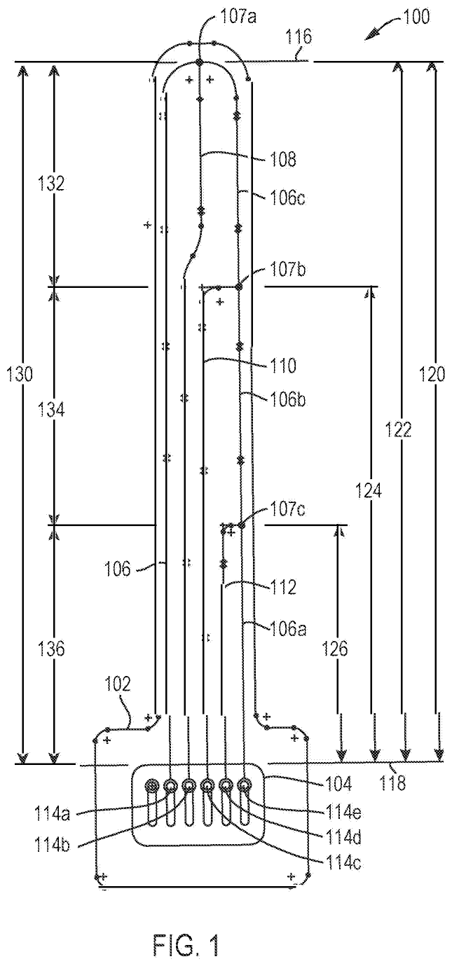

Referring now to FIG. 1, a circuit 100 with multiple tap points 107a-c is depicted in accordance with at least one non-limiting aspect of the present disclosure. According to the non-limiting aspect of FIG. 1, the circuit 100 can include a substrate layer 102, an electric component 104, a common trace 106, a first sensing trace 108, a second sensing trace 110, and a third sensing trace 112.

According to some non-limiting aspects, the circuit 100 can include a multi-layer construction, including a substrate layer 102 upon which traces 106, 108, 110, 112 made from deformable conductor are deposited and encapsulated (e.g., by an encapsulation layer). The material used for the encapsulation layer may be similar to, or the same as, the substrate layer 102 and both layers may include flexible and/or stretchable materials. The electric component 104 may be disposed on one or both of the encapsulation and substrate 102 layers and be in electrical communication with the traces 106, 108, 110, 112 by means of interconnects extending through the layer(s). An exemplary interconnect structure may include vias that extend through a layer, and which may be at least partially filled with a deformable conductor of the same or different type used to form the traces 106, 108, 110, 112. Such an interconnect configuration can enable electrical communication between a variety of components, features and parts of the circuit 100. The multi-layer construction can, for example, be similar to those disclosed in International Patent Application No. PCT/US2022/070850, titled DEVICES, SYSTEMS, AND METHODS FOR MAKING AND USING HIGHLY SUSTAINABLE CIRCUITS, which was filed on Feb. 25, 2022 and published on Sep. 1, 2022 as International Patent Publication No. WO2022/183217A1, and/or International Patent Application No. PCT/US2019/047731, titled STRUCTURES WITH DEFORMABLE CONDUCTORS, which was filed on Aug. 22, 2019 and published on Feb. 27, 2020 as International Patent Publication No. WO2020/041605A1, the disclosures of which are hereby incorporated by reference in their entirety. For example, according to some non-limiting aspects, the multi-layer construction can include a substrate layer, a stencil-layer, and an encapsulation layer. However, according to other non-limiting aspects, the circuits can include traces integrated to a two-layer construction (e.g., substrate layer, encapsulation layer, etc.) or even a single layer (e.g., by casting a material around the traces 106, 108, 110, 112). According to still other non-limiting aspects, when integrated to an article, a material of the article can serve as one or more of the layers of the circuit 100.

It shall be appreciated that any of the aforementioned layers can be constructed from any one of a number of polymers, such as, for example, thermoplastic polyurethane (TPU), high density polyethylene (HDPE), polyethylene terephthalate (PET), polyvinyl chloride (PVC), low density polyethylene (LDPE), polypropylene (PP) and/or polystyrene (PS), amongst others. However, according to other non-limiting aspects, any of the layers can be made from epoxy-based materials, such as, for example, B-stage resin films. The epoxy-based materials can be used as an additional discrete component to provide a self-adhesive surface for bonding electric components to any layer and/or for bonding layers to each other. In various other aspects, substantially all layers, adhesives and encapsulants of any of the circuit assemblies disclosed herein can be made from thermally activated adhesives, such as, for example, thermoplastic polyurethane (TPU) adhesives (e.g., from Bemis or Framis). In yet other aspects, any of the layers, adhesives, and/or encapsulants of the circuit assembly can include thermoset adhesives such as, for example, silicones, acrylics, and any pressure sensitive adhesive of any chemistry. In the case of encapsulant materials (e.g., encapsulants applied to terminals of an electric component), the concentration of thermoset material included in the encapsulant may be minimal, allowing the material to be readily recyclable. In one aspect, the circuit assemblies disclosed herein can include fillers including thermoset materials. Fillers including thermoset material may be reused in a “re-grind” format to strengthen, modify, or lower the cost of articles made from a similar thermosetting material.

Still referring to FIG. 1, each trace of the circuit 100 (e.g., common trace 106, first sensing trace 108, second sensing trace 110, and third sensing trace 112) and any interconnects, such as vias, can include conductive materials having a variety of forms, such as a liquid, a paste, a gel, a powder, an elastic and/or soft solid, and/or combinations thereof that would enable each trace to have a deformable (e.g., soft, flexible, stretchable, bendable, elastic, flowable, viscoelastic, Newtonian, non-Newtonian, etc.) quality. According to some non-limiting aspects, the circuit 100 can be formed from the deformable conductor described in International Patent Application No. PCT/US2017/019762, titled LIQUID WIRE, which was filed on Feb. 27, 2017 and published on Sep. 8, 2017 as International Patent Publication No. WO2017/151523A1 and/or International Patent Application No. PCT/US2019/047731, titled STRUCTURES WITH DEFORMABLE CONDUCTORS, which was filed on Aug. 22, 2019 and published on Feb. 27, 2020 as International Patent Publication No. WO2020/041605A1, the disclosures of which are hereby incorporated by reference in their entirety.

For example, the traces 106, 108, 110, 112 of the circuit 100 can be constructed from a material that includes a fluid-phase conductor. “Fluid-phase conductors” can include a variety of forms, such as a liquid, a paste, a gel, a powder, and/or combinations thereof, amongst others that would enable the traces to have a deformable quality as detailed above. According to some non-limiting aspects, the deformable conductor can include an electroactive material, and may comprise a conductive gel (e.g., a gallium indium alloy processed into a gel or Bingham plastic phase). The deformable conductor can be a shear thinning composition and, according to some non-limiting aspects, can include a mixture of materials in a desired ratio. For example, according to one preferable non-limiting aspect, the conductive gel can include a weight percentage of a eutectic gallium alloy in a range of 59.9% and 99.9% and a weight percentage of a gallium oxide in a range of 0.1% and about 2.0%. Of course, the present disclosure contemplates other non-limiting aspects featuring traces 106, 108, 110, 112 and interconnects of varying forms and/or compositions to achieve the benefits disclosed herein.

The use of a conductive gel for traces 106, 108, 110, 112 can provide for circuits 100 that are flexible, stretchable, extensible and deformable while maintaining durability and resiliency. Moreover, the operational flexing, stretching, deforming, or other physical manipulation of a conductive trace formed from conductive gel may produce predictable, measurable changes in the electrical characteristics of the trace with little to no hysteresis upon returning to a relaxed state.

The electrically conductive compositions can be characterized as conducting shear thinning gel compositions. The electrically conductive compositions described herein can also be characterized as compositions having the properties of a Bingham plastic. For example, the electrically conductive compositions can be viscoplastics, such that they are rigid and capable of forming and maintaining three-dimensional features characterized by height and width at low stresses but flow as viscous fluids at high stress. According to other non-limiting aspects, the low-shear viscosity of useful metal gel can be 10\hat{ }6 to 4×10\hat{ }7 Pa*s (1,000,000-40,000,000 Pascal seconds), wherein “low-shear” viscosity refers to a viscosity at rest (or sedimentation) conditions. The micro/nanostructure comprises oxide sheets that form a cross-linked structure, which may be achieved, for example, by mixing in a way that entrains air into the mixture, or by sonication that induces cavitation at the surface drawing in air to the mixture such that oxide formation in the cross-linked structures can be achieved.

In some examples, the circuit 100 can be made using a deformable conductive material optimized to have a viscosity or other property that enables gaps or “opens” in the traces 106, 108, 110, 112, to heal upon, during, or after the addition of an encapsulation layer. Such gaps or opens may be intentionally or unintentionally introduced during the manufacturing of the circuit assembly, such as during patterning of the traces. Healing of gaps or opens in the traces 106, 108, 110, 112 may occur during a unitization step, or upon or after deforming the circuit 100 after it has been constructed. Methods of manufacturing a circuit assembly that include a unitization step are described in U.S. patent application Ser. No. 17/651,651 titled STRUCTURES WITH DEFORMABLE CONDUCTORS, which was filed on Feb. 18, 2022 and published on Aug. 25, 2022 as U.S. Patent Publication No. US2022/0270961A1. In another example, if a removable stencil is used to pattern the traces 106, 108, 110, 112, the adhesive characteristics and/or viscosity of the deformable conductive material may be optimized such that it remains on the substrate layer upon removal of the removable stencil but does not adhere to the channels of the stencil. Thereby, removing the stencil does not result in lifting the deformable conductive material from the substrate layer.

It shall be appreciated that, by integrating deformable conductors into a circuit 100, various sensor types can be constructed. As used herein, a “sensing variable” refers to a measurable electrical parameter or characteristic of a sensing trace that varies in response to physical deformation of the sensing trace or the common trace, or both. Non-limiting examples of a sensing variable include a resistance, an impedance, a voltage, a voltage drop, a current, an inductance, a capacitance, and an electromagnetic field characteristic. According to some non-limiting aspects, such sensors can generate varying electrical parameters and characteristics (e.g., a sensing variable such as, for example, an inductance, a resistance, a voltage drop, a capacitance, and an electromagnetic field, etc.) in response to physical manipulations to their structure (e.g., bending, folding, stretching, compressing, inflating, deflating, etc.). Measured values for various electrical characteristics or parameters can therefore be directly correlated to various and specific physical changes to the circuit 100 (e.g., a strain, a stress, an elongation, a pressure, a dimension, a shape, an angle, a radius, etc.). The circuit 100 may be readily incorporated into a wide variety of articles including both rigid, pliable, and stretchable structures. For example, circuit 100 may be incorporated to wearable articles (e.g., a glove, a shoe, a sleeve, a brace, a cuff, a shirt, a watch, a pair of pants, a sock, etc.). In other examples, circuit 100 may be integrated to a structural article (e.g., a fuselage, a wing, a helicopter blade, an airfoil, a panel, an inflatable structure such as a tire or a tube, etc.), or a variety of other types of articles. Regardless of the type of article circuit 100 is incorporated to, changes in the electrical parameters and characteristics can be directly correlated to changes to physical parameters and characteristics of the article.

Accordingly, the circuit 100 of FIG. 1 can be used to measure, track and/or log physical changes of an article. Physical change data collected and/or transmitted by the circuit 100 can, for example, be used to generate simulations or real time virtual representations of physical changes to the article. In the case of a wearable article that conforms to at least a portion of a wearer's body, simulations or virtual representations of physical features, physical changes, or physical movements of at least that the wearer's body portion can be generated. In some non-limiting examples, the circuit 100 of FIG. 1 can be used to track and/or generate simulations of a wearer's limb(s) and/or digit(s) movements, and/or changes in the wearer's anatomy (e.g., swelling of a body part, etc). To enable such measuring, monitoring, tracking and/or logging of physical characteristics, at least a portion of the circuit 100 can be configured as a sensor (e.g., a strain sensor, etc.). As such, circuit 100 and associated traces 106, 108, 110, 112 can be implemented in a variety of configurations. For example, the circuit 100 can be integrated to any wearable article, such as those described in International Patent Application No. PCT/US2021/071374, titled WEARABLE ARTICLE WITH FLEXIBLE INDUCTIVE PRESSURE SENSOR, which was filed on Sep. 3, 2021 and published on Mar. 10, 2022 as International Patent Publication No. WO2022/051776A1, the disclosure of which is hereby incorporated by reference in its entirety. According to other non-limiting aspects of FIG. 1, a wearable article incorporating the circuit 100 can be a glove, a joint monitoring sleeve or brace, a shoe, a sock, a pant, an undergarment, a shirt, a unitard, a sleeve, a jacket, a hat, a wrap, eyeglasses, a piece of equipment, a patch, and portions or components thereof.

In the example of FIG. 1, the circuit 100 is configured as a strain sensor. The electric component 104 includes a first contact 114a, a second contact 114b, a third contact 114c, a fourth contact 114d, and a fifth contact 114e. Contacts 114a-e may be provided to interconnect the electric component 104 to the traces 106, 108, 110, 112 by means of vias that extend through the encapsulation layer. The interconnects are substantially filled with a deformable conductor (e.g., the same as used for the traces, or a different type of deformable conductor), placing the electric component 104 in electrical communication with the traces 106, 108, 110, 112.

The common trace 106 extends along a first direction from the first contact 114a to a distal sensing limit 116, and returns to the electric component 104, extending along a second direction, in this example substantially opposite to the first direction, from the distal sensing limit 116 to the fifth contact 114e, and passing through a proximal sensing limit 118. The proximal and distal sensing limits 118, 116 define a sensing range 120 between them. In this example, the proximal sensing limit 118 is coincident with the boundary between electric component 104 and the encapsulation layer, however, it shall be appreciated that the proximal sensing limit can vary in location along the first and second directions. In some examples, the proximal sensing limit 118 may be defined by a transition from a stretchable to a non-stretchable structure of the circuit 100, or a transition from a rigid to a more pliable structure. The sensing range 120 may therefore be the active range of the sensor along at least the first direction, from the proximal limit 118 (e.g., the limit closest to the electric component) to the distal limit 116 (e.g., the limit furthest from the electric component). In some embodiments, the sensing range 120 may define the range over which it is desired for the sensor to physically deform and generate signals used to correlate to physical changes in the sensor to physical changes in the article to which the sensor is applied. In such embodiments, sensing traces 108, 110, 112 may be located entirely within the sensing range 120. In other embodiments, the sensing range 120 may define the range over which the common trace extends, in at least the first direction, and all tap points 107a-c may be located entirely within the range, and one or more of the sensing traces 108, 110, 112 may extend beyond the sensing range 120, thereby defining at least a second sensing range for that sensing trace, if so provided.

It shall be appreciated that the sensing traces 108, 110, 112 may be directly coupled to the common trace 106 via intersection in a single layer at the respective tap points 107a-c. That is, the sensing traces and the common trace can be formed in the same plane on the substrate layer 102, with the sensing traces physically intersecting the common trace at the tap points. Alternatively, according to other non-limiting aspects, the sensing traces may be electrically coupled to the common trace through vias or other interconnects extending between different layers of a multi-layer circuit construction. The plurality of sensing traces 108, 110, 112 may be collectively referred to herein as a “sensing trace array.”

It shall be appreciated that the electric component 104 may be a control circuit communicably coupled or otherwise in electrical communication to the circuit 100, and optionally the control circuit may be physically attached to one or both of the circuit 100 and/or the electric component 104. For example, according to some non-limiting aspects, a control circuit can be mechanically coupled to a wearable article and/or the circuit 100 and electrically coupled to the circuit 100 directly or using a bus. According to other non-limiting aspects, the control circuit can be located remotely from the circuit 100 and/or the article and configured for wireless communication with the circuit 100, for example, by means of a wireless radio incorporated to the electric component 104. It shall be appreciated that the control circuit may be physically attached or mechanically coupled, either removably or permanently, to the article but may not be in electrical communication with the circuit 100. In some embodiments, the control circuit can be implemented via, or integrated to, an edge device (e.g., a tablet, a mobile phone, a computer, etc.). Alternatively, the control circuit may be implemented via, or integrated to, a remote device (e.g., a computer, a server, etc.) connected to the article through a network (e.g., a wireless network) either directly or by communicating with an edge device connected to the article.

According to the non-limiting aspects of FIG. 1, the common trace 106 can be connected to the electric component 104 at the first contact 114a and the fifth contact 114e. As such, the common trace 106 can be configured to provide a “control” signal to be received at the fifth contact 114e by providing an electrical input at the first contact 114a. Because the common trace 106 is formed from the aforementioned deformable conductors, physical manipulations of the circuit 100 can alter electrical parameters of the electrical input traversing, or conducted by, the common trace 106. For example, as the circuit 100 is deformed, electrical parameters such as an inductance, a resistance, a voltage, a capacitance, and/or an electromagnetic field, amongst others, will vary over time as the physical and electrical characteristics of the common trace change in response to the deformations (e.g., as the circuit 100 is stretched, the common trace 106 elongates reducing the cross-sectional area of the trace, increasing its resistance). Accordingly, the signal can be correlated to the electrical characteristics associated with the common trace 106, which in turn can be correlated to a variety of physical characteristics or change in physical characteristics associated with the circuit 100, such as a strain, a stress, a pressure, an elongation, a bend angle or radius, a shape and/or another dimension or geometric parameter, amongst others. Changes in the electrical characteristic(s) of the trace 106 that are monitored, tracked, logged and/or measured over time, therefore, can be correlated to physical changes over time to the circuit, and thereby the article within the sensing range 120. Since, as previously mentioned, the control signal supplied or generated by the common trace 106 is associated with changes to the electrical parameter across the entirety of the common trace 106, it may be difficult to assess one or more discrete changes in a physical characteristic of the article, whereby each discrete change occurs in a different portion of the range 120.

However, according to the non-limiting aspects of FIG. 1, the circuit 100 includes the first tap point 107a, the second tap point 107b, and the third tap point 107c disposed at different locations of the common trace 106 along the first direction. The first sensing trace 108 can be connected to the electric component 104 at the second contact 114b and to the common trace 106 at the first tap point 107a, the second sensing trace 110 can be connected to the electric component 104 at the third contact 114c and to the common trace 106 at the second tap point 107b, and the third sensing trace 112 can be connected to the electric component 104 at the fourth contact 114d and to the common trace 106 at the third tap point 107c. The first sensing trace 108, the second sensing trace 110, and the third sensing trace 112 extend at least partially along the first and/or second directions within the sensing range 120. Since each tap point 107a-c is located at a different distance from the proximal limit 118 along the first direction, and each sensing trace 108, 110, 112 extends a different distance back to the electric component 104 and to the proximal limit 118, each sensing trace defines a discrete sensing subrange within the sensing range 120. In this example, the first sensing trace 108 defines a first sensing subrange 122 that extends from the first tap point 107a to the proximal sensing limit 118. The second sensing trace 110 defines a second sensing subrange 124 that extends from the second tap point 107b to the proximal sensing limit 118. The third sensing trace 112 defines a third sensing subrange 126 that extends from the third tap point 107c to the proximal sensing limit 118. The three sensing subranges 122, 124, 126 are within the sensing range 120, and at least partially overlap one another along the first direction.

Each sensing trace 108, 110, 112 has at least one electrical characteristic (e.g., a resistance, an impedance, etc.) that is different than a corresponding electrical characteristic of the common trace 106. In particular, the sensing traces 108, 110, 112 may have an impedance that is greater than an impedance of the common trace 106. For example, the impedance of each sensing trace may be greater than or equal to approximately 1 megohm. Because the impedance of each sensing trace is significantly greater than the impedance of the common trace 106, the electrical input traversing the common trace 106 takes the path of least resistance and remains substantially on the common trace 106 while a relatively small current is diverted through each sensing trace, thereby enabling the sensing traces to measure, or “probe,” the voltage at their respective tap points without substantially altering the electrical characteristic of the common trace 106.

Each sensing trace receives the same electrical input (e.g., a constant electrical parameter, such as a constant current or a constant voltage) conducted by the common trace 106, which may be supplied by the electric component 104. Thus, when the circuit 100 is in a neutral state, each sensing trace 108, 110, 112 will supply the electric component 104 with a signal. For example, the first sensing trace 108 may output a first signal, the second sensing trace 110 may output a second signal, and the third sensing trace 112 may output a third signal. In one example, the electric component 104 supplies the common trace 106 with a constant current at contact 114a and measures voltages at contacts 114b-e. Thus, the signals may each comprise a voltage, and the control circuit can calculate a resistance for each trace 106, 108, 110, 112 from their respective signal utilizing Ohm's law. In such an example, the constant current supplied to the common trace 106 at contact 114a must be sufficient enough that current may flow through the entire common trace 106 from contact 114a to contact 114e, while also allowing current to flow through each of the sensing traces 108, 110, 112 to contacts 114b-d, respectively. In another example, the electrical input may be a constant voltage and the signals may comprise a current, and resistance again calculated by the control circuit. As the circuit is deformed from the neutral, or resting, state, the signals will change along with the physical and electrical characteristics and/or associated parameters of the circuit 100 (e.g., the resistances of the traces 106, 108, 110, 112). Thus, the signals may be used to correlate the change in electrical parameters of the circuit 100 to changes in physical parameters of the circuit 100, and therefore to physical changes of an article that the circuit 100 is integrated to. Correlation may be entirely performed by the control circuit and may involve one more methods and inputs including empirical testing and empirical testing data, simulation and simulation data, machine learning, artificial intelligence modeling, algorithmic modeling, and/or a variety of other methods.

Although the foregoing examples describe the constant electrical parameter as a constant direct current (DC) or a constant voltage, it shall be appreciated that, according to other non-limiting aspects, the control circuit may apply other forms of controlled excitation to the common trace 106. For example, the control circuit may apply a controlled alternating current (AC) excitation, a pulsed excitation, or another known electrical stimulus, depending on whether the electrical parameter of interest is resistance, impedance, capacitance, inductance, or another electrical characteristic. In such aspects, the sensing variable generated by each sensing trace may correspondingly include an AC voltage, an impedance, a phase angle, or another parameter responsive to the applied excitation.

Utilizing the exemplary configuration shown in FIG. 1, the control circuit can therefore correlate from the received signals (e.g., the control signal, the first, second, and third signals), for example, using background subtraction: an overall physical change to the circuit 100 within a common zone 130; a first physical change to the circuit 100 within a first sensing zone 132; a second physical change to the circuit 100 within the second sensing zone 134; and a third physical change to the circuit 100 within the third sensing zone 136.

Although the non-limiting aspect of FIG. 1 employs a single common trace 106 and three sensing traces 108, 110, 112, it shall be appreciated that the non-limiting aspect of FIG. 1 is merely illustrative. As such, it shall be appreciated that, according to other non-limiting aspects of the present disclosure, the principles and techniques described in reference to FIG. 1 can be similarly employed to create circuits with any number of common traces and any number of sensing traces arranged in any number of geometrical configurations (e.g., 2D or 3D) optimized for a variety of applications. Thus, while three generally linearly arranged sensing zones are shown in FIG. 1, by providing any number of common traces having any desired geometric configuration or shape with any number of tap points and associated sensing traces originating at the tap points, one can create shape of sensing circuit 100 with any number of sensing zones. Therefore, the principles taught herein may be used to create circuits that can be integrated to a wide variety of articles to log, monitor, track and/or measure physical changes to the article from changes to the circuit's electrical parameters and/or characteristics at multiple discrete locations of the article by processing the signals received by control and sensing traces.

Should a desired configuration of sensing zones require that sensing traces or common traces intersect, and such intersections would render the circuit inoperable, such intersections (in plain view normal to the surface of the circuit) may be configured to occur in different planes by providing the circuit with multiple, vertically stacked trace layers (e.g., multiple substrate layers in a stacked relationship). Where electrical communication is required between the layers, vias may be used to conduct signals, electrical inputs or parameters throughout the circuit as needed.

According to non-limiting aspects of FIG. 1, the circuit 100 as shown can be integrated to a glove to measure physical characteristics, or combinations of physical characteristics, associated with different parts of a hand (e.g., portions of a finger, worn within the glove). By measuring and logging physical characteristics associated with the hand with respect to time, a user could measure deformations of the glove, and/or at least one portion of the glove where deformation occurs, and infer or correlate these deformations to the motion of the wearer's hand, or a portion thereof. In one non-limiting example, the circuit 100 may be a strain sensor integrated to a finger portion of a glove such that each zone 130, 132, 134, 136 is configured to generate signals from each trace 106, 108, 110, 112. The signals may be logged over time, for example, at a specified sampling rate by a memory. The first sensing zone 132 may be configured to overlay the distal interphalangeal joint of the finger, the second sensing zone 134 may be configured to overlay the proximal interphalangeal joint of the finger, and the third sensing zone 136 may be configured to overlay the metacarpophalangeal joint of the finger. Configured in this way, the circuit 100 may be used to calculate and log discrete changes in, for example, resistance of each trace 106, 108, 110, 112 over time, which may be correlated to the change in relative joint angles between each segment of the finger and the metacarpus.

In any application of circuit 100 to an article, information relating to deformation and the location(s) of deformation of the circuit 100 may be used to measure, log, and/or track physical motions in a real environment and/or simulate motions in a virtual environment, and/or to understand relevant trends and information relating to the article. In the example of a wearable article worn on a body, such measuring, tracking, logging, simulating and/or gathering of trends and information may be useful for an injury-prone, recently-injured, or surgically-repaired area of the body. Similarly, according to non-limiting aspects wherein the circuit 100 is integrated to such a wearable article (e.g., a brace or garment adapted or configured for use with one or more of a neck, shoulder, elbow, wrist, hip, back, knee, ankle, or the like), the multi-tap circuit configuration of FIG. 1 can measure, monitor, log, and/or track an angle, a strain, a stress, a pressure, a dimension, a volume, a position, a shape, etc., or any combination and/or rates of change thereof, among other physical characteristics associated with a region of the body protected or encompassed by the brace or garment.

Although various non-limiting aspects disclosed herein suggest the implementation of the circuit 100 to a wearable article such as a glove, a brace, or other garments, it shall be appreciated that these various non-limiting aspects are merely illustrative. As such, it shall be appreciated that, according to other non-limiting aspects, the circuit 100 may be modified and/or implemented for use by any number of wearable and/or non-wearable articles where it may be useful to monitor, log, track, and/or measure multiple or different portions of those articles.

According to still other non-limiting aspects, the circuit 100 can be integrated to a non-wearable article such as an inflatable structure. For example, the circuit 100 can be integrated to a tire, an inflatable bladder, a pneumatic actuator, or a deployable structure, wherein the multi-tap configuration enables the measurement of physical characteristics such as pressure, inflation level, strain distribution, or structural integrity at multiple discrete zones of the inflatable structure. In another example, the circuit 100 can be integrated to a structural panel, a composite layup, or a building element, wherein the multi-tap configuration enables monitoring of strain, stress, or deformation at multiple locations for structural health monitoring purposes.

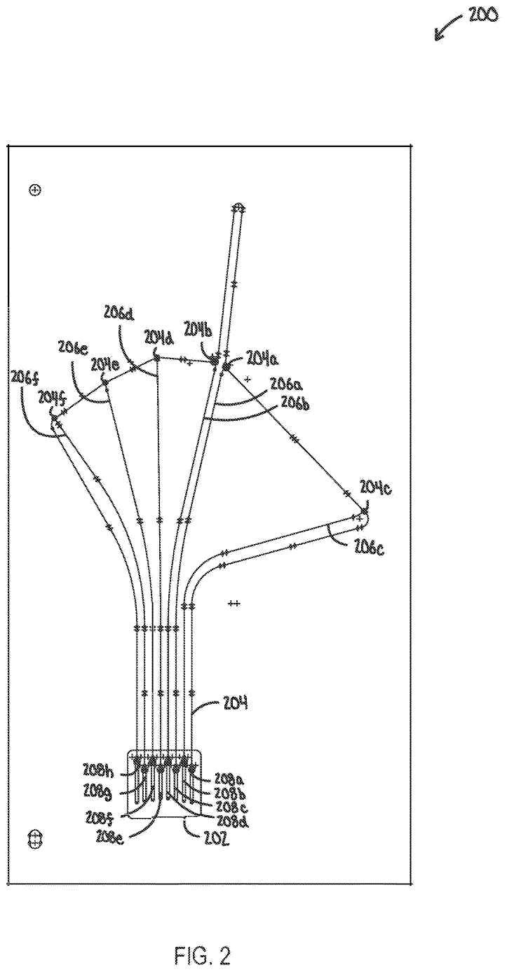

Referring now to FIG. 2, another circuit 200 is depicted in accordance with at least one non-limiting aspect of the present disclosure. The circuit 200 of FIG. 2 illustrates a fan topology, in contrast to the linear topology of the circuit 100 depicted in FIG. 1. The circuit 200 of FIG. 2 can be configured for use with an article, such as a glove, although it shall be appreciated that the circuit 200 can be modified for use with other articles, such as a sleeve, a brace, a shirt, pants, shorts, or a sock, amongst others. For example, the circuit 200 can be configured for use with articles such as those described in International Patent Application No. PCT/US2021/071374, titled WEARABLE ARTICLE WITH FLEXIBLE INDUCTIVE PRESSURE SENSOR, filed Sep. 3, 2021 and published on Mar. 10, 2022 as International Patent Publication No. WO2022/051776A1, the disclosure of which is hereby incorporated by reference in its entirety herein.

According to the non-limiting aspect of FIG. 2, the circuit 200 can include an electric component 202, a common trace 204, a first sensing trace 206a, a second sensing trace 206b, a third sensing trace 206c, a fourth sensing trace 206d, a fifth sensing trace 206e, and a sixth sensing trace 206f. It shall be appreciated that the traces 204, 206a-f of the circuit 200 and the construction of the circuit 200 itself can be similarly configured to those described in reference to FIG. 1. The electric component 202 can further include a first contact 208a, a second contact 208b, a third contact 208c, a fourth contact 208d, a fifth contact 208e, a sixth contact 208f, a seventh contact 208g, and an eighth contact 208h. The common trace 204 can further include a first tap point 204a, a second tap point 204b, a third tap point 204c, a fourth tap point 204d, a fifth tap point 204e, and a sixth tap point 204f. According to other non-limiting aspects of FIG. 2, the circuit 200 can further include a control circuit, and the control circuit can be communicably coupled to the circuit 200 via the electric component 202 and at least one of a wired or wireless connection.

According to the non-limiting aspect of FIG. 2, the common trace 204 can be connected to the electric component 202 via the first contact 208a and the eighth contact 208h. As such, the common trace 204 can be configured to allow a signal to flow from the first contact 208a to the eighth contact 208h. Additionally, the first sensing trace 206a can be connected to the electric component 202 via the third contact 208c and to the common trace 204 via the first tap point 204a, the second sensing trace 206b can be connected to the electric component 202 via the fourth contact 208d and to the common trace 204 via the second tap point 204b, the third sensing trace 206c can be connected to the electric component 202 via the second contact 208b and to the common trace 204 via the third tap point 204c, the fourth sensing trace 206d can be connected to the electric component 202 via the fifth contact 208e and to the common trace 204 via the fourth tap point 204d, the fifth sensing trace 206e can be connected to the electric component 202 via the sixth contact 208f and to the common trace 204 via the fifth tap point 204e, and the sixth sensing trace 206f can be connected to the electric component 202 via the seventh contact 208g and to the common trace 204 via the sixth tap point 204f.

It should be noted, for brevity purposes, that the circuit 200 only illustrates two sensing traces (e.g., first sensing trace 206a and second sensing trace 206b) for one finger (e.g., index finger). Each of the remaining fingers (e.g., thumb, middle finger, ring finger, and pinky finger) as shown in FIG. 2 include one sensing trace and one tap point. However, as would be appreciated and understood by those having ordinary skill in the art, each of the remaining fingers may similarly include two sensing traces and two tap points, in the manner illustrated for the index finger.

As a result, an electrical characteristic can be measured for each portion of the common trace 204 to determine a physical characteristic associated with each portion of the common trace 204. As described above, the circuit 200 can be configured for use with an article such as a glove. As a result, there are two types of portions of the common trace 204 for which an electrical characteristic can be measured. The first portion type can include a single finger (e.g., between first tap point 204a and second tap point 204b), and the second portion type can include an area between two fingers (e.g., between fourth tap point 204d and fifth tap point 204e).

In a first example, for the first portion type, an electrical characteristic can be measured across a first portion of the common trace 204 based on a signal reading at the third contact 208c and the fourth contact 208d, where the signal reading at the third contact 208c is received via the first sensing trace 206a tapping the common trace 204 at the first tap point 204a, and where the signal reading at the fourth contact 208d is received via the second sensing trace 206b tapping the common trace 204 at the second tap point 204b. Based on the measured electrical characteristic across the first portion, a physical characteristic can be determined for the first portion. Similarly, in a second example, for the second portion type, an electrical characteristic can be measured across a second portion of the common trace 204 based on a signal reading at the fifth contact 208e and the sixth contact 208f, where the signal reading at the fifth contact 208e is received via the fourth sensing trace 206d tapping the common trace 204 at the fourth tap point 204d, and where the signal reading at the sixth contact 208f is received via the fifth sensing trace 206e tapping the common trace 204 at the fifth tap point 204e. Based on the measured electrical characteristic across the second portion, a physical characteristic can be determined for the second portion. According to the non-limiting aspect of FIG. 2, an electrical characteristic can include an inductance, a resistance, a voltage drop, a capacitance, or an electromagnetic field, or combinations thereof, and a physical characteristic can include a strain, a stress, a pressure, or a dimension, or combinations thereof. According to other non-limiting aspects of FIG. 2, the circuit 200 can include any number of sensing traces and tap points to measure an electrical characteristic, and thus determine a physical characteristic, across any number of portions of the common trace 204.

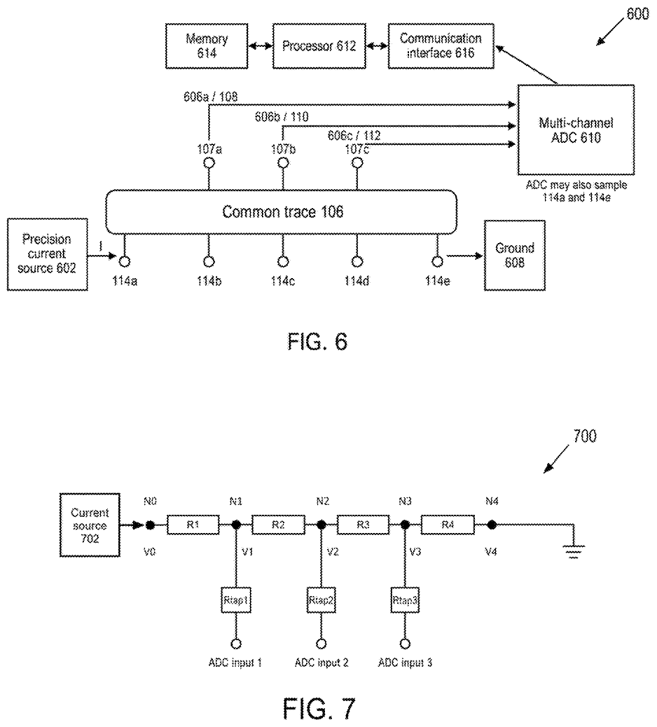

It shall be appreciated that the sensing range, sensing zone, sensing subrange, and sensing variable concepts described herein with reference to FIG. 1 and circuit 100 are equally applicable to the fan-branching topology of circuit 200 of FIG. 2. For example, each branch of the common trace 204 extending to a respective finger portion of a glove can define a sensing range, and the sensing traces 206a-f tapping into the common trace 204 at respective tap points 204a-f can define sensing zones and sensing subranges within each branch's sensing range, in the manner described with reference to FIG. 1. The measurement system 600 of FIG. 6 can be used with the fan-branching topology of FIG. 2. It shall be appreciated that, for a branched topology such as circuit 200, the processor 612 (FIG. 6) may employ techniques such as nodal analysis, selective excitation of individual branches, or time-division scanning of branches to resolve the resistance of each segment, rather than or in addition to the simple series-resistance model of the equivalent circuit 700 of FIG. 7. The processor 612 may further employ branch-specific calibration data stored in the memory 614 to account for the branched current paths.

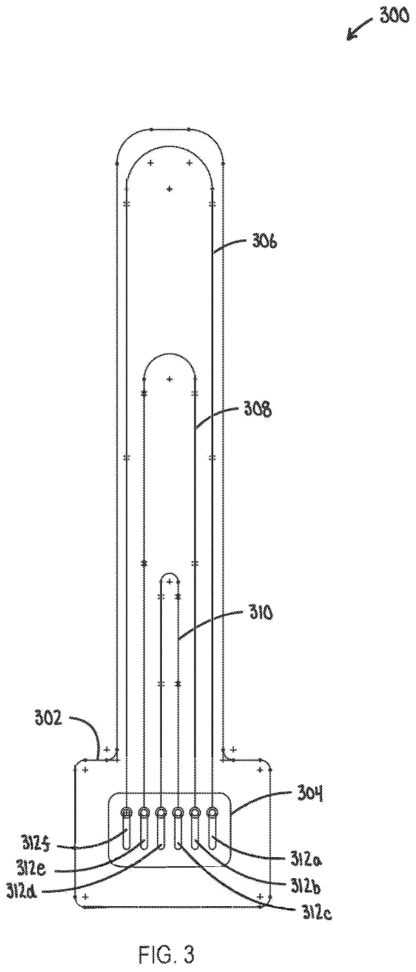

Referring now to FIG. 3, another circuit 300 is depicted in accordance with at least one non-limiting aspect of the present disclosure, and is configured for the determination of physical characteristics associated with multiple portions of the circuit 300. Unlike the circuit 100 of FIG. 1 and the circuit 200 of FIG. 2, the circuit 300 of FIG. 3 does not include sensing traces that tap into a common trace and is thus configured for the determination of physical characteristics associated with multiple portions of the circuit with a plurality of discrete sensing traces. As such, according to the non-limiting aspect of FIG. 3, the non-multi-tap circuit 300 can include a substrate layer 302, an electric component 304, a first sensing trace 306, a second sensing trace 308, and a third sensing trace 310. The sensing traces 306, 308, 310 can be deposited or patterned on the substrate layer 302 and encapsulated by an encapsulation layer. The material used for the encapsulation layer may be similar to, or the same as, the substrate layer 302 and both layers may include flexible and/or stretchable materials.

According to the non-limiting aspect of FIG. 3, the electric component 304 can further include a first contact 312a, a second contact 312b, a third contact 312c, a fourth contact 312d, a fifth contact 312e, and a sixth contact 312f. The first sensing trace 306 can be connected to the electric component 304 at the first contact 312a and the sixth contact 312f, the second sensing trace 308 can be connected to the electric component 304 at the second contact 312b and the fifth contact 312e, and the third sensing trace 310 can be connected to the electric component 304 at the third contact 312c and the fourth contact 312d. Because each sensing trace 306, 308, 310 is formed from the aforementioned deformable conductors, physical manipulations of the circuit 300 can alter electrical parameters of the electrical input traversing, or conducted by, the sensing traces 306, 308, 310.

The first sensing trace 306 extends along a first direction from the contact 312a to a distal sensing limit 316 and returns to the electric component 304 along a second direction, passing through a proximal sensing limit 318, and terminating at the sixth contact 312f. The proximal and distal sensing limits 318, 316 define a sensing range 320 between them. The second sensing trace 308 defines a first sensing subrange 322 that extends from the proximal sensing limit 318 to a second sensing limit 321. The third sensing trace 310 defines a second sensing subrange 324 that extends from the proximal sensing limit 318 to a third sensing limit 323. The sensing subranges 322, 324 are within the sensing range 320, and all three ranges at least partially overlap one another along the first direction.

Utilizing the exemplary configuration shown in FIG. 3, the control circuit can therefore correlate from the received signals (e.g., the first, second, and third signals), for example, using background subtraction: an overall physical change to the circuit 300 within a common zone 330; a first physical change to the circuit 300 within a first sensing zone 332; a second physical change to the circuit 300 within a second sensing zone 334; and a third physical change to the circuit 300 within a third sensing zone 336.

By utilizing the non-multi-tap circuit 300 of FIG. 3, a user—or a control circuit communicably coupled to the circuit 300—can obtain a physical characteristic associated with each trace 306, 308, 310, however, the user would be unable to obtain specific data relating to which portion (e.g., first 332, second 334, and/or third 336 sensing zone) of each trace 306, 308, 310 affected the physical characteristic, where applicable. That is, a user would be unable to determine which portion of each trace 306, 308, 310 has been deformed, thus causing a change in a physical characteristic. As similarly described above with reference to FIGS. 1 and 2, such specific data identifying where deformation has occurred (e.g., first 332, second 334, and/or third 336 sensing zones) can be important when analyzing data received from the non-multi-tap circuit 300. This limitation of the non-multi-tap configuration of FIG. 3 is addressed by the multi-tap configurations of FIGS. 1 and 2, which enable zone-specific physical characteristic determination as described herein.

Referring now to FIG. 6, a measurement system 600 is depicted in block diagram form in accordance with at least one non-limiting aspect of the present disclosure. As described herein, the circuit 100 of FIG. 1 can be connected to a measurement device, such as an analog to digital converter (ADC), for the purpose of digitizing voltage signals received at the contacts 114a-e of the electric component 104 and processing such signals to determine physical characteristics associated with multiple zones of the circuit 100. According to non-limiting aspects, the measurement system 600 can include a precision current source 602, a common trace 106 represented schematically as a series of resistance segments between successive tap points 107a-c, a plurality of sensing traces 606a, 606b, 606c corresponding to the first sensing trace 108, the second sensing trace 110, and the third sensing trace 112, respectively, a ground connection 608, a multi-channel analog to digital converter (ADC) 610, a processor 612, a memory 614, and a communication interface 616. It shall be appreciated that the measurement system 600 represents the measurement architecture that a person having ordinary skill in the art would understand to be encompassed by the measurement device and the control circuit described herein with reference to FIG. 1 and the associated contacts 114a-e of the electric component 104.

According to non-limiting aspects of FIG. 6, the precision current source 602 can be connected to the first contact 114a of the electric component 104 and configured to supply a constant current through the common trace 106. The ground connection 608 can be connected to the fifth contact 114e of the electric component 104, thereby establishing a current path from the precision current source 602, through the common trace 106, to the ground connection 608. As the constant current flows through the common trace 106, a voltage develops across each segment of the common trace 106 between successive contacts and tap points in accordance with Ohm's law (V=I×R), where V is the voltage across a given segment, I is the constant current supplied by the precision current source 602, and R is the resistance of that segment. The sensing traces 606a, 606b, 606c can be connected to the common trace 106 at the first tap point 107a, the second tap point 107b, and the third tap point 107c, respectively, and can serve as high-impedance voltage probes. Because each sensing trace 606a, 606b, 606c presents a substantially higher impedance than the corresponding segment of the common trace 106, current flow through the sensing traces 606a, 606b, 606c is negligible relative to the current flowing through the common trace 106, and the sensing traces 606a, 606b, 606c therefore minimally disturb the current distribution in the common trace 106 while conveying the voltage present at each respective tap point 107a-c to the corresponding contact 114b, 114c, 114d of the electric component 104.

According to non-limiting aspects of FIG. 6, the multi-channel ADC 610 can include a plurality of input channels connected to the contacts 114a-e of the electric component 104. The ADC 610 can be configured to receive the analog voltage signals present at each of the contacts 114a, 114b, 114c, 114d, and 114e, and to convert each analog voltage signal to a corresponding digital representation. According to some non-limiting aspects, the ADC 610 can employ sequential sampling, whereby the ADC 610 samples each channel in turn using a multiplexer. According to other non-limiting aspects, the ADC 610 can employ simultaneous sampling, whereby each channel is sampled at substantially the same time to avoid timing skew between channels. It shall be appreciated that the resolution of the ADC 610 can be selected based on the application requirements. For example, according to some non-limiting aspects, the ADC 610 can have a resolution of at least 12 bits, at least 16 bits, or at least 24 bits. Higher resolution can enable the measurement system 600 to detect smaller changes in the resistance of each segment of the common trace 106, thereby improving sensitivity to smaller physical deformations of the circuit 100. The sampling rate of the ADC 610 can be selected to enable real-time or near-real-time monitoring of physical changes to the circuit 100 and any article to which the circuit 100 is integrated. For example, according to some non-limiting aspects, the ADC 610 can be configured to sample at a rate sufficient to capture the dynamics of physical deformations of interest, such as human movement, structural loading, or other physical phenomena.

According to non-limiting aspects of FIG. 6, the processor 612 can be communicatively coupled to the ADC 610 and configured to receive the digital representations of the voltage signals from the ADC 610. The processor 612 can be a microcontroller unit (MCU), a digital signal processor, a microprocessor, a field-programmable gate array, or any other suitable processing device. The processor 612 can be configured to compute, from the digitized voltage values at each contact 114a-e, the resistance of each segment of the common trace 106 between successive contacts and tap points using the known constant current supplied by the precision current source 602. The memory 614 can be communicatively coupled to the processor 612 and configured to store the digitized voltage data, computed resistance values, calibration data, and any other data associated with the operation of the measurement system 600. The communication interface 616 can be communicatively coupled to the processor 612 and configured to transmit data to and receive data from an external device. According to some non-limiting aspects, the communication interface 616 can include a wireless communication module, such as a Bluetooth, Bluetooth Low Energy, Wi-Fi, Zigbee, or other wireless radio. According to other non-limiting aspects, the communication interface 616 can include a wired communication interface, such as a Universal Serial Bus (USB), Serial Peripheral Interface (SPI), Inter-Integrated Circuit (I2C), or Universal Asynchronous Receiver-Transmitter (UART) interface. It shall be appreciated that some or all of the precision current source 602, the ADC 610, the processor 612, the memory 614, and the communication interface 616 can be incorporated to, or implemented by, the electric component 104 and/or a control circuit communicably coupled to the circuit 100, as described herein with reference to FIGS. 1 and 4-5.

According to some non-limiting aspects, the measurement system 600 can further include signal conditioning circuitry disposed between the sensing traces 606a, 606b, 606c and the ADC 610. The signal conditioning circuitry can include one or more of buffer amplifiers configured to present a high input impedance to the sensing traces while driving the ADC input channels at low impedance, anti-aliasing filters configured to attenuate signal frequencies above the Nyquist frequency of the ADC 610, and electrostatic discharge (ESD) protection circuitry. According to some non-limiting aspects, the buffer amplifiers can be operational amplifiers configured in a voltage-follower (unity-gain) configuration, which can further reduce the current drawn through the sensing traces 606a, 606b, 606c and thereby further minimize disturbance to the voltage distribution in the common trace 106.

According to some non-limiting aspects, the processor 612 can be configured to perform a calibration procedure prior to, or periodically during, operation of the measurement system 600. The calibration procedure can include measuring the voltages at each node N0-N4 while the circuit 100 is in a known physical state, such as a relaxed or undeformed state, and storing the resulting baseline voltage values and computed baseline resistance values in the memory 614. Subsequent measurements during deformation of the circuit 100 can be compared to the baseline values to determine the change in resistance of each segment, which can be correlated to the physical deformation. According to some non-limiting aspects, the calibration procedure can further include applying one or more known physical deformations to the circuit 100 and recording the corresponding resistance changes, thereby establishing a calibration function or lookup table mapping resistance changes to specific physical characteristics such as bend angle, strain, or elongation. According to some non-limiting aspects, the processor 612 can be further configured to perform fault detection, including detecting open-circuit or short-circuit conditions in one or more traces by comparing measured resistance values to expected ranges, and logging fault events in the memory 614.

According to some non-limiting aspects, the measurement system 600 can further include a temperature sensor communicatively coupled to the processor 612. Because the resistance of deformable conductors, such as gallium-based alloys, can vary with temperature independently of physical deformation, the processor 612 can be configured to compensate for temperature-induced resistance changes by measuring the ambient temperature via the temperature sensor and applying a temperature correction factor to the measured resistance values. The temperature correction factor can be determined during calibration and stored in the memory 614.

According to some non-limiting aspects, the ADC 610 can be configured to perform differential voltage measurements between adjacent channels, rather than or in addition to single-ended measurements referenced to a common ground. Differential measurement can improve the signal-to-noise ratio of the resistance computation for each segment of the common trace 106 by rejecting common-mode noise present at both nodes bounding the segment.

Referring now to FIG. 7, an equivalent circuit 700 is depicted in accordance with at least one non-limiting aspect of the present disclosure. The equivalent circuit 700 represents an electrical model of the multi-tap circuit 100 of FIG. 1 as measured by the measurement system 600 of FIG. 6. According to non-limiting aspects of FIG. 7, the equivalent circuit 700 can include a current source 702, a plurality of nodes N0, N1, N2, N3, and N4 corresponding to the locations of the contacts and tap points of the circuit 100, a plurality of series resistances R_1, R_2, R_3, and R_4 representing successive segments of the common trace 106 between adjacent nodes, and a plurality of shunt resistances R_tap1, R_tap2, and R_tap3 representing the sensing traces 108, 110, 112, respectively. Node N0 corresponds to the first contact 114a, node N1 corresponds to the first tap point 107a, node N2 corresponds to the second tap point 107b, node N3 corresponds to the third tap point 107c, and node N4 corresponds to the fifth contact 114e. A voltage V_0 is present at node N0, a voltage V_1 is present at node N1, a voltage V_2 is present at node N2, a voltage V_3 is present at node N3, and a voltage V_4 is present at node N4. The current source 702 can be connected at node N0, and the ground connection can be at node N4, such that a constant current I flows from node N0 to node N4 through the series resistances R_1, R_2, R_3, and R_4.

According to non-limiting aspects of FIG. 7, a key operating condition of the equivalent circuit 700 is that the shunt resistances R_tap1, R_tap2, and R_tap3 are each substantially greater than the series resistances R_1, R_2, R_3, and R_4 (that is, R_tap>>R_segment). This condition ensures that the sensing traces 108, 110, 112 function as high-impedance voltage probes that draw negligible current from the common trace 106, as described herein with reference to FIG. 6. Under this condition, substantially all of the constant current I supplied by the current source 702 flows through the series path of R_1, R_2, R_3, and R_4, and the voltage at each node can be determined by the cumulative voltage drops across the series resistances downstream of that node. The resistance of each individual segment of the common trace 106 can therefore be computed by background subtraction of the voltages at adjacent nodes. For example, the resistance of the segment between node N1 and node N2 can be computed as R_2=(V_1−V_2)/I, where V_1 and V_2 are the voltages measured at node N1 and node N2, respectively, via the first sensing trace 108 and the second sensing trace 110, and I is the known constant current. More generally, for any segment between adjacent nodes N_n and N_{n+1}, the segment resistance can be expressed as R_segment_n =(V_n−V_{n+1})/I.

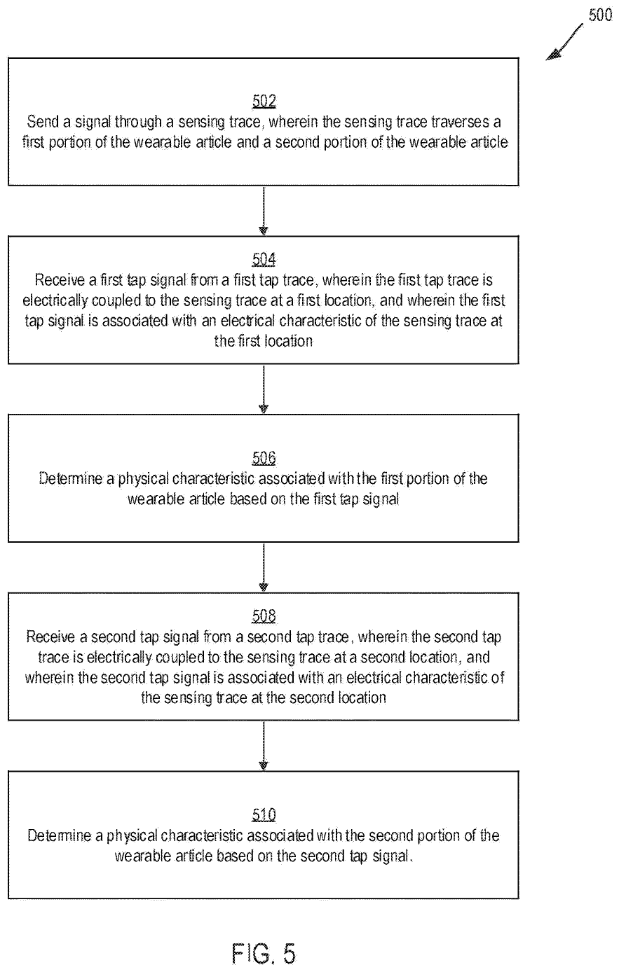

According to non-limiting aspects of FIG. 7, because the resistance of each segment of the common trace 106 changes in a predictable manner in response to physical deformation of the circuit 100, the equivalent circuit 700 enables physical changes to be isolated to specific zones of the circuit 100. For example, if the circuit 100 is integrated to an article and a physical deformation occurs in the zone corresponding to the segment between node N1 and node N2, the resistance R_2 of that segment will change while the resistances R_1, R_3, and R_4 of the remaining segments will remain substantially unchanged. The processor 612 (FIG. 6) can detect this localized change by computing the individual segment resistances from the measured nodal voltages and identifying which segment or segments have changed relative to a baseline or prior measurement. It shall be appreciated that the background subtraction technique described herein with reference to the equivalent circuit 700 is consistent with the background subtraction described herein with reference to FIGS. 1 and 5, and that the equivalent circuit 700 is an electrical representation of the physical multi-tap circuit structure of FIG. 1 as it would be understood by a person having ordinary skill in the art.

As a non-limiting example illustrating the background subtraction technique, consider a case in which the precision current source 602 supplies a constant current I of 1.0 milliampere through the common trace 106, and the measurement system 600 measures the following voltages at the respective nodes: V_0=5.000V at node N0, V_1=3.750V at node N1, V_2=2.500V at node N2, V_3=1.125V at node N3, and V_4=0.000V at node N4. The processor 612 can compute the resistance of each segment by subtracting adjacent nodal voltages and dividing by the known current: R_1=(V_0−V_1)/I=(5.000−3.750)/0.001=1,250 ohms; R_2=(V_1−V_2)/I=(3.750−2.500)/0.001=1,250 ohms; R_3=(V_2−V_3)/I=(2.500−1.125)/0.001=1,375 ohms; R_4=(V_3−V_4)/I=(1.125−0.000)/0.001=1,125 ohms. These baseline resistance values can be stored in the memory 614. If the circuit 100 is subsequently deformed in the zone corresponding to the segment between nodes N1 and N2, a subsequent measurement might yield V_1=3.900V and V_2=2.200V, resulting in R_2=(3.900−2.200)/0.001=1,700 ohms, representing a 36% increase in resistance for that segment while the remaining segments remain substantially unchanged. The processor 612 can thereby identify the deformation as localized to the second sensing zone 134 and can correlate the change in resistance to a corresponding physical deformation, such as a bend angle, using calibration data stored in the memory 614.

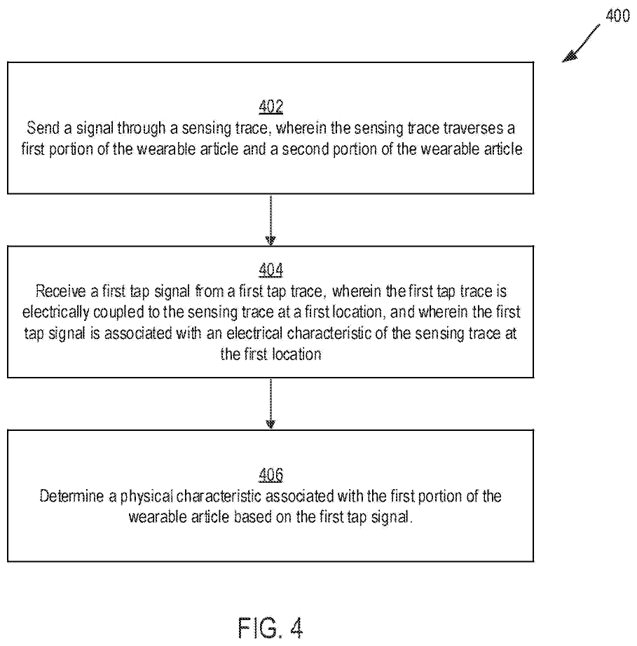

Referring now to FIG. 4, a method 400 of determining a physical characteristic associated with a first portion of an article is depicted in accordance with at least one non-limiting aspect of the present disclosure. According to some non-limiting aspects, the method 400 can be performed by a control circuit communicably coupled to the circuit 100 of FIG. 1 or the circuit 200 of FIG. 2. According to the non-limiting aspect of FIG. 4, the method 400 can include sending 402, by a control circuit, a signal through a common trace. The common trace can traverse a first portion of an article and a second portion of the article. For example, the common trace 106 (FIG. 1) can traverse a first portion 106a (FIG. 1), between the first contact 114a (FIG. 1) and the first tap point 107a (FIG. 1), and a second portion 106b (FIG. 1), between the first tap point 107a (FIG. 1) and the second tap point 107b (FIG. 1), of the multi-tap circuit 100 (FIG. 1) for use with an article.

In further reference to FIG. 4, the method 400 can further include receiving 404, by a control circuit, a first tap signal from a first sensing trace. The first sensing trace can be electrically coupled to the common trace at a first location, and the first tap signal can be associated with an electrical characteristic of the common trace at the first location. For example, the first sensing trace 108 (FIG. 1) can be electrically coupled to the common trace 106 (FIG. 1) at the first tap point 107a (FIG. 1) (e.g., a first location). Furthermore, the first tap signal can be associated with an electrical characteristic of the common trace 106 (FIG. 1) at the first tap point 107a (FIG. 1) (e.g., the first location). The method 400 can further include determining 406, by a control circuit, a physical characteristic associated with the first portion of the article based on the first tap signal. For example, the method 400 can determine a physical characteristic associated with the first portion 106a, between the first contact 114a (FIG. 1) and the first tap point 107a (FIG. 1), based on the first tap signal received from the first sensing trace 108 (FIG. 1).

It shall be appreciated that sending 402, receiving 404, and determining 406 form the basis of the method 400, however, the method 400 can include additional, or fewer, functionalities to determine a physical characteristic associated with a first portion of an article, according to other non-limiting aspects of the present disclosure.

Referring now to FIG. 5, a method 500 of determining a physical characteristic associated with a first portion of an article and a physical characteristic associated with a second portion of the article is depicted in accordance with at least one non-limiting aspect of the present disclosure. As would be appreciated and understood by those having ordinary skill in the art, the method 500 of FIG. 5 can include similar functionalities from the method 400 (FIG. 4). The method 500, for example, can be performed by a control circuit of the multi-tap circuit 100 (FIG. 1) or the multi-tap circuit 200 (FIG. 2). According to the non-limiting aspect of FIG. 5, the method 500 can include sending 502, by a control circuit, a signal through a common trace. The common trace can traverse a first portion of an article and a second portion of the article. For example, the common trace 106 (FIG. 1) can traverse a first portion 106a, between the first contact 114a (FIG. 1) and the first tap point 107a (FIG. 1), and a second portion 106b, between the first tap point 107a (FIG. 1) and the second tap point 107b (FIG. 1), of the multi-tap circuit 100 (FIG. 1) for use with an article.

In further reference to FIG. 5, the method 500 can further include receiving 504, by a control circuit, a first tap signal from a first sensing trace. The first sensing trace can be electrically coupled to the common trace at a first location, and the first tap signal can be associated with an electrical characteristic of the common trace at the first location. For example, the first sensing trace 108 (FIG. 1) can be electrically coupled to the common trace 106 (FIG. 1) at the first tap point 107a (FIG. 1) (e.g., a first location). Furthermore, the first tap signal can be associated with an electrical characteristic of the common trace 106 (FIG. 1) at the first tap point 107a (FIG. 1) (e.g., the first location). The method 500 can further include determining 506, by a control circuit, a physical characteristic associated with the first portion of the article based on the first tap signal. For example, the method 500 can determine a physical characteristic associated with the first portion 106a, between the first contact 114a (FIG. 1) and the first tap point 107a (FIG. 1), based on the first tap signal received from the first sensing trace 108 (FIG. 1).

In further reference to FIG. 5, the method 500 can further include receiving 508, by a control circuit, a second tap signal from a second sensing trace. The second sensing trace can be electrically coupled to the common trace at a second location, and the second tap signal can be associated with an electrical characteristic of the common trace at the second location. For example, the second sensing trace 110 (FIG. 1) can be electrically coupled to the common trace 106 (FIG. 1) at the second tap point 107b (FIG. 1) (e.g., a second location). Furthermore, the second tap signal can be associated with an electrical characteristic of the common trace 106 (FIG. 1) at the second tap point 107b (FIG. 1) (e.g., the second location). The method 500 can further include determining 510, by the control circuit, a physical characteristic associated with the second portion of the article based on the second tap signal. For example, the method 500 can determine a physical characteristic associated with the second portion 106b, between the first tap point 107a (FIG. 1) and the second tap point 107b (FIG. 1), based on the second tap signal received from the second sensing trace 110 (FIG. 1).

It shall be appreciated that sending 502, receiving 504, determining 506, receiving 508, and determining 510 form the basis of the method 500, however, the method 500 can include additional, or fewer, functionalities to determine a physical characteristic associated with a first portion of an article and a physical characteristic associated with a second portion of the article, according to other non-limiting aspects of the present disclosure.

Since the inventive principles of this patent disclosure can be modified in arrangement and detail without departing from the inventive concepts, such changes and modifications are considered to fall within the scope of the following claims. The use of terms such as first and second are for purposes of differentiating different components and do not necessarily imply the presence of more than one component.

In some aspects, a viscosity of the deformable conductive material may, when under high shear (e.g., in motion), be in a range of about 10 Pascal seconds (Pas) and 500 Pas, such as a range of 50 Pas and 300 Pas. In some aspects, a viscosity of the deformable conductive material may, when under low shear (e.g., at rest), be in a range of 1,000,000 Pas and 40,000,000 Pas.

The electrically conductive compositions can comprise a mixture of a eutectic gallium alloy and gallium oxide, wherein the mixture of eutectic gallium alloy and gallium oxide has a weight percentage (wt %) in a range of about 59.9% and about 99.9% eutectic gallium alloy, and a wt % in a range of about 0.1% and about 2.0% gallium oxide. The eutectic gallium alloy can include gallium-indium or gallium-indium-tin in any ratio of elements. The electrically conductive compositions can have any suitable percentage of gallium by weight in the gallium-indium alloy that is in a range of about 40% and about 95%. The electrically conductive compositions can have a percentage of indium by weight in the gallium-indium alloy that is in a range of about 5% and about 60%. The eutectic gallium alloy can include gallium and tin, and the electrically conductive compositions can have a percentage of tin by weight in the alloy that is in a range of about 0.001% and about 50%.

The electrically conductive compositions can comprise one or more micro-particles or sub-micron scale particles blended with the eutectic gallium alloy and gallium oxide. The particles can be suspended within eutectic gallium alloy. The micro-or sub-micron scale particles can range in size from nanometer to micrometer and can be suspended in gallium, gallium-indium alloy, or gallium-indium-tin alloy. In certain embodiments, the one or more micro-particles or sub-micron particles are blended with the electrically conductive compositions with wt % in a range of about 0.001% and about 40.0% of micro-particles. The one or more micro-or sub-micron particles can be made of any suitable material including soda glass, silica, borosilicate glass, quartz, oxidized copper, silver coated copper, non-oxidized copper, tungsten, super saturated tin granules, glass, graphite, copper flakes, or copper spheres, or a combination thereof, or any other material that can be wetted by the eutectic gallium alloy. The one or more micro-particles or sub-micron scale particles can have any suitable shape, including the shape of spheroids, rods, tubes, flakes, plates, cubes, prismatic, pyramidal, cages, and dendrimers. The one or more micro-particles or sub-micron scale particles can have any suitable size, including a size range of about 0.5 microns to about 60 microns. The addition of any ancillary material to the colloidal suspension or eutectic gallium alloy may enhance or modify the physical, electrical, or thermal properties of the electrically conductive compositions.

The electrically conductive compositions described herein can be made by any suitable method, including a method comprising blending surface oxides formed on a surface of a eutectic gallium alloy into the bulk of the eutectic gallium alloy by shear mixing of the surface oxide/alloy interface. Shear mixing of such compositions can induce a cross-linked microstructure in the surface oxides, thereby forming a conducting shear thinning gel composition. A colloidal suspension of micro-structures can be formed within the eutectic gallium alloy/gallium oxide mixture, for example as gallium oxide particles and/or sheets. The eutectic gallium alloy can include gallium-indium or gallium-indium-tin in any ratio of elements. The weight percentage of gallium in the gallium-indium-tin alloy can be in a range of about 40% and about 95%, and the weight percentage of indium in the gallium-indium-tin alloy can be in a range of about 5% and about 60%.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention.

As used in any aspect herein, any reference to a processor or microprocessor can be substituted for any “control circuit,” which may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.).

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 20%, 10%, 5%, 4%, 3%, 2%, 1%, 0.5%, or 0.05% of a given value or range.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

What is claimed is:

1. A circuit, comprising:
a plurality of traces formed from a deformable, fluid-phase conductor, wherein the plurality of traces comprise: a common trace defining a sensing range; and
a sensing trace electrically coupled to the common trace at a tap point within the sensing range,
wherein the common trace is configured to conduct a constant electrical parameter, wherein the sensing trace defines a sensing zone at least partially overlapping the sensing range, and wherein the sensing trace is configured to generate a sensing variable within the sensing zone.

2. The circuit of claim 1, wherein the sensing trace is directly coupled to the common trace via intersection in a single layer at the tap point.

3. The circuit of claim 1, further comprising a control circuit communicably coupled to the common trace and the sensing trace, wherein the control circuit is configured to:
generate the constant electrical parameter;
receive a first signal from the common trace, wherein the first signal is associated with the constant electrical parameter; and
receive a second signal from the sensing trace, wherein the second signal is associated with the sensing variable.

4. The circuit of claim 3, further comprising:
a current source coupled to a first end of the common trace and configured to supply a constant current through the common trace; and
an analog-to-digital converter communicably coupled to the sensing trace and configured to measure a voltage at the tap point; and
wherein the control circuit comprises a processor in communication with the analog-to-digital converter, the processor configured to determine the physical characteristic based on the measured voltage.

5. The circuit of claim 4, wherein the common trace is coupled to a ground reference at a second end, and wherein the analog-to-digital converter is further communicably coupled to the first end and the second end of the common trace.

6. The circuit of claim 5, wherein the processor is further configured to calculate a resistance of a portion of the common trace based on the constant current and a voltage difference between two measurement points along the common trace, the two measurement points including at least one of the tap point, the first end, or the second end.

7. The circuit of claim 1, wherein the sensing trace is a first sensing trace; and
wherein the circuit further comprises:
a sensing trace array comprising the first sensing trace;
at least one additional sensing trace; and
wherein each additional sensing trace:
is electrically coupled to the common trace at an additional tap point within the sensing range,
defines an additional sensing zone at least partially overlapping the sensing range, and
is configured to generate an additional sensing variable within the additional sensing zone.

8. The circuit of claim 1, wherein the constant electrical parameter comprises a current; and
wherein the sensing variable comprises at least one of an inductance, a resistance, a voltage, a capacitance, or an electromagnetic field.

9. The circuit of claim 1, wherein the sensing trace has an impedance of at least 1 megohm, and wherein the impedance of the sensing trace is greater than an impedance of the common trace such that the sensing trace minimally disturbs a current distribution in the common trace.

10. The circuit of claim 1, wherein the common trace extends from a first limit to a second limit and returns from the second limit to at least the first limit, wherein the first limit and the second limit define the sensing range.

11. A system, comprising:
an article; and
a circuit integrated to the article, the circuit comprising:
a plurality of traces formed from a deformable, fluid-phase conductor, wherein the plurality of traces comprise:
a common trace configured to traverse a first portion of the article and a second portion of the article;
a sensing trace electrically coupled to the common trace at a tap point; and
a control circuit communicably coupled to the plurality of traces, wherein the control circuit is configured to:
receive a signal from the sensing trace, wherein the signal is associated with an electrical characteristic of the common trace at the tap point; and
determine a physical characteristic associated with the first portion of the article based on the signal.

12. The system of claim 11, wherein the article is a wearable article comprising at least one of a glove, a sleeve, a brace, a shoe, or a sock.

13. The system of claim 11, wherein the sensing trace is a first sensing trace, wherein the tap point is a first tap point, wherein the signal is a first signal; and
wherein the plurality of traces further comprise a second sensing trace electrically coupled to the common trace at a second tap point; and
wherein the control circuit is further configured to:
receive a second signal from the second sensing trace, wherein the second signal is associated with an electrical characteristic of the common trace at the second tap point; and
determine a physical characteristic associated with the second portion of the article based on the first signal and the second signal.

14. The system of claim 11, wherein the sensing trace has an impedance greater than an impedance of the common trace; and
wherein a difference between the impedance of the sensing trace and the impedance of the common trace enables the sensing trace to transmit the signal to the control circuit without substantially altering the electrical characteristic of the common trace.

15. The system of claim 11, wherein the physical characteristic comprises at least one of a position, an angle, a strain, a stress, a pressure, a dimension, a shape, a combination of at least two physical characteristics, or rates of change thereof.

16. The system of claim 11, wherein the circuit further comprises a sensing trace array including the sensing trace and a plurality of additional sensing traces, and wherein the common trace includes a plurality of branches, each branch extending to a respective portion of the article, the sensing trace and the plurality of additional sensing traces being distributed across at least two of the plurality of branches such that the control circuit is configured to determine physical characteristics associated with portions of the article corresponding to different branches of the common trace.

17. A method of determining a physical characteristic associated with a portion of an article, comprising:
providing a constant electrical parameter to a common trace, wherein the common trace and a sensing trace are each formed from a deformable, fluid-phase conductor, and wherein the sensing trace is electrically coupled to the common trace at a tap point;
receiving, by a control circuit, a first signal from the common trace, wherein the first signal is associated with the constant electrical parameter;
receiving, by the control circuit, a second signal from the sensing trace, wherein the second signal is associated with a sensing variable generated within a sensing zone defined by the sensing trace; and
determining, by the control circuit, a physical characteristic associated with a first portion of the article based on at least the first signal and the second signal.

18. The method of claim 17, wherein determining the physical characteristic comprises performing background subtraction by subtracting measurements taken at two different nodes along the common trace, at least one of the two different nodes being a tap point, to determine a local segment resistance of a portion of the common trace between the two different nodes.

19. The method of claim 17, wherein receiving the first signal comprises measuring a first voltage at a first terminal of the common trace, and wherein receiving the second signal comprises measuring a second voltage at a terminal of the sensing trace.

20. The method of claim 17, wherein the sensing trace is a first sensing trace, the method further comprising:
receiving, by the control circuit, a third signal from a second sensing trace electrically coupled to the common trace at a second tap point, wherein the third signal is associated with a sensing variable generated within a second sensing zone defined by the second sensing trace; and
determining, by the control circuit, a physical characteristic associated with a second portion of the article based on the second signal and the third signal.

21. The method of claim 17, wherein the sensing trace has an impedance greater than an impedance of the common trace, and wherein a difference between the impedance of the sensing trace and the impedance of the common trace enables the sensing trace to convey the second signal to the control circuit without substantially altering the constant electrical parameter conducted by the common trace.
